(19) United States
(12) Patent Application Publication
(10) Pub. No.: US 2019/0281615 A1
(43) Pub. Date: Sep. 12, 2019

(54) COMMUNICATION CONTROL APPARATUS AND COMMUNICATION CONTROL METHOD

(71) Applicant: CANON KABUSHIKI KAISHA, Tokyo (JP)

(72) Inventor: Kenichirou Hayashi, Kawasaki-shi (JP)

(21) Appl. No.: 16/288,424

(22) Filed: Feb. 28, 2019

(30) Foreign Application Priority Data
Mar. 6, 2018 (JP) 2018-039642

(51) Int. Cl. H04W 72/12; H04W 72/04

(52) U.S. Cl. CPC H04W 72/1263; H04W 84/12; H04W 72/0453

(57) ABSTRACT

There is provided a communication control apparatus. A control unit performs control such that first wireless communication with an external apparatus is conducted via a first communication unit according to first setting information. In a case where a communication execution instruction about a second communication unit is detected while the first wireless communication is being conducted, the control unit stops the first wireless communication, and performs control such that second wireless communication with the external apparatus is conducted via the second communication unit according to the first setting information. In a case where the communication execution instruction is detected when the first wireless communication is not conducted, the control unit performs control such that third wireless communication with the external apparatus is conducted via the second communication unit according to second setting information.

### BACKGROUND OF THE INVENTION

### Field of the Invention

The present invention relates to a communication control apparatus and a communication control method.

### Description of the Related Art

Currently, a product which includes a digital camera with a built-in wireless LAN function has been prevailing. However, the built-in wireless LAN function of the camera body is often configured such that a communication distance is relatively short (e.g., about 10 m) in order to suppress heat generation, power consumption, or the like of the camera body. Accordingly, among cameras with built-in wireless LAN functions, some cameras are configured such that external accessories (wireless LAN accessories) including wireless LAN functions with longer communication distances are attachable. In this case, communication setting needs to be performed for the wireless LAN accessory. For example, Japanese Patent Laid-Open No. 2013-187713 discloses a configuration in which communication setting for a built-in wireless LAN function is copied to a storage region of a memory card including an external wireless LAN function.

However, it is not always desirable that the communication setting for the built-in wireless LAN function be used for the wireless LAN accessory. For example, for a camera to which a wireless LAN accessory is attachable, a communication application exists that is enabled only when the wireless LAN accessory is attached in some cases. In such cases, depending on circumstances, a user may want to use communication setting different from the communication setting for the built-in wireless LAN function, for the wireless LAN accessory.

### SUMMARY OF THE INVENTION

The present invention is made in view of the above circumstance, and provides a technology that makes it possible to use appropriate communication setting, when wireless communication is conducted, according to whether another wireless communication is being conducted.

According to a first aspect of the present invention, there is provided a communication control apparatus, comprising: a control unit configured to perform control such that first wireless communication with an external apparatus is conducted via a first communication unit according to first setting information; and a detection unit configured to detect a communication execution instruction about a second communication unit, wherein the control unit is configured to, in a case where the communication execution instruction is detected while the first wireless communication is being conducted, stop the first wireless communication, and perform control such that second wireless communication with the external apparatus is conducted via the second communication unit according to the first setting information, and the control unit is configured to, in a case where the communication execution instruction is detected when the first wireless communication is not conducted, perform control such that third wireless communication with the external apparatus is conducted via the second communication unit according to second setting information different from the first setting information.

According to a second aspect of the present invention, there is provided a communication control apparatus, comprising: a control unit configured to control a first communication device built in a communication apparatus, and a second communication device attached to the communication apparatus; and a detection unit configured to detect a communication execution instruction about the second communication device, wherein the control unit is configured to, in a case where the detection unit detects the communication execution instruction while the first communication device is conducting wireless communication with an external apparatus via a communication network formed by the first communication device, perform control such that wireless communication by the first communication device is stopped, and the second communication device uses setting regarding the communication network to form a new communication network and conducts wireless communication with the external apparatus via the newly formed communication network.

According to a third aspect of the present invention, there is provided a communication control method executed by a communication control apparatus, comprising: performing control such that first wireless communication with an external apparatus is conducted via a first communication unit according to first setting information; detecting a communication execution instruction about a second communication unit; in a case where the communication execution instruction is detected while the first wireless communication is being conducted, stopping the first wireless communication, and performing control such that second wireless communication with the external apparatus is conducted via the second communication unit according to the first setting information; and in a case where the communication execution instruction is detected when the first wireless communication is not conducted, performing control such that third wireless communication with the external apparatus is conducted via the second communication unit according to second setting information different from the first setting information.

According to a fourth aspect of the present invention, there is provided a communication control method executed by a communication control apparatus, comprising: detecting a communication execution instruction about a second communication device attached to a communication apparatus; and in a case where the communication execution instruction is detected while a first communication device built in the communication apparatus is conducting wireless communication with an external apparatus via a communication network formed by the first communication device, performing control such that wireless communication by the first communication device is stopped, and the second communication device uses setting regarding the communication network to form a new communication network and conducts wireless communication with the external apparatus via the newly formed communication network.

Further features of the present invention will become apparent from the following description of exemplary embodiments with reference to the attached drawings.

### BRIEF DESCRIPTION OF THE DRAWINGS

FIG. 1 is a block diagram illustrating a configuration of an image capturing apparatus 100 including a communication control apparatus.

FIG. 2 is a block diagram illustrating a configuration of an accessory apparatus 200.

FIG. 3 is a flowchart of remote live view processing using a built-in wireless LAN.

FIGS. 4A to 4C are diagrams illustrating menu screen examples of the built-in wireless LAN.

FIG. 5 is a diagram for explaining connection between an accessory installation unit 118 of the image capturing apparatus 100 and an image capturing apparatus connection unit 210 of the accessory apparatus 200.

FIG. 6 is a flowchart of remote live view processing using an external wireless LAN.

FIGS. 7A to 7C are diagrams illustrating menu screen examples of the external wireless LAN.

FIG. 8 is a diagram illustrating a memory map of a non-volatile memory 107.

FIG. 9 is a flowchart of switching processing of wireless communication according to a first embodiment.

FIG. 10 is a flowchart of frequency switching processing.

FIG. 11 is a flowchart of switching processing of wireless communication according to a second embodiment.

FIGS. 12A to 12C are diagrams illustrating message examples displayed during the switching processing of the wireless communication.

FIG. 13 is a diagram illustrating selection criteria for radio field intensity display.

FIG. 14 is a flowchart of switching processing of wireless communication according to a third embodiment.

### DESCRIPTION OF THE EMBODIMENTS

Hereinafter, embodiments of the present invention will be described with reference to the attached drawings. Elements that are given the same reference numerals throughout all of the attached drawings represent the same or similar elements. Note that the technical scope of the present invention is defined by the claims, and is not limited by the following respective embodiments. Also, not all of the combinations of the aspects that are described in the embodiments are necessarily essential to the present invention. Also, the aspects that are described in the individual embodiments can be combined as appropriate.

### First Embodiment

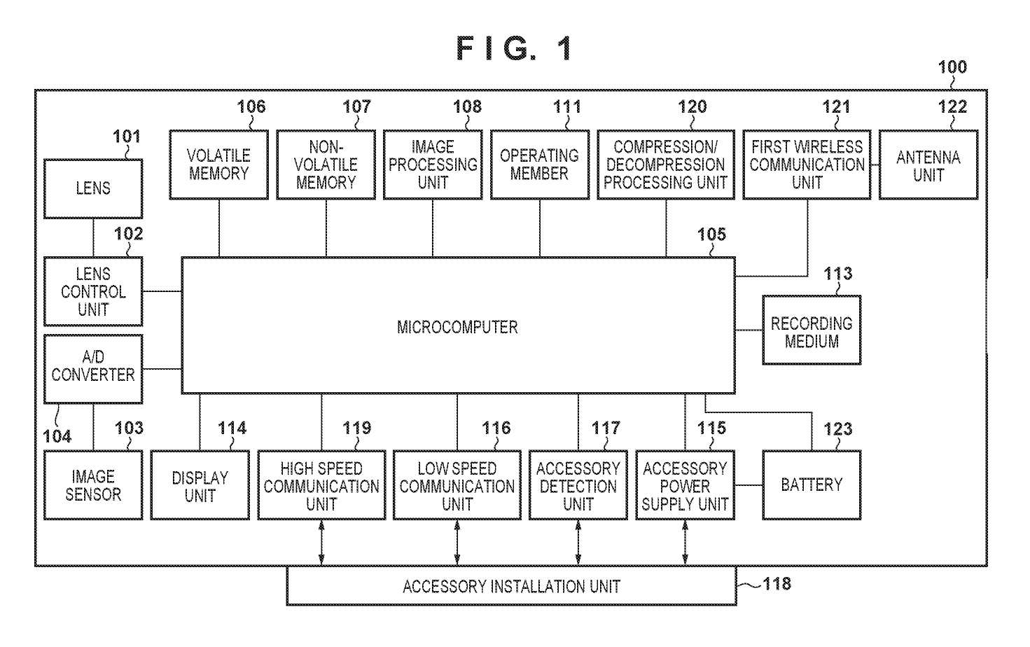

FIG. 1 is a block diagram illustrating a configuration of the image capturing apparatus 100 including a communication control apparatus. In FIG. 1, a numeral 101 denotes a lens, and light from an object is obtained through the lens 101. The lens 101 may be integral with the image capturing apparatus 100, or may be removable. A numeral 102 denotes a lens control unit, which performs control/management of the lens 101 such as zoom control, aperture control, obtainment of a zoom direction, or a zoom position for the lens 101. The lens control unit 102 may be installed on the image capturing apparatus 100 side or may be installed on the lens 101 side. A numeral 103 denotes an image sensor, which accumulates light information obtained through the lens 101 as electrical charge. A numeral 104 denotes an A/D converter, which converts the accumulated electrical charge information in the image sensor 103 to digital data.

A numeral 121 denotes a first wireless communication unit, which wirelessly transfers a captured image generated in the image capturing apparatus 100 to a peripheral device such as a personal computer. In the present embodiment, the first wireless communication unit 121 conducts wireless LAN communication in a 2.4 GHz band. A numeral 122 denotes an antenna unit for emitting a wireless LAN signal in the 2.4 GHz band output from the first wireless communication unit 121. In the following descriptions, the first wireless communication unit 121 may also be referred to as a built-in wireless LAN.

A numeral 105 denotes a microcomputer, which performs operation control, image processing sequence control, moving image compression control, or the like for the image capturing apparatus 100. Additionally, the microcomputer 105 performs communication control for the first wireless communication unit 121, the accessory apparatus 200 (described later), or the like. A numeral 106 denotes a volatile memory. The volatile memory 106 is used to control the microcomputer 105, used as a primary storage destination for pixel information obtained from the image sensor 103 or image information transferred by the first wireless communication unit 121, or used for processing by an image processing unit 108. A numeral 107 denotes a non-volatile memory, in which a program for controlling the microcomputer 105, parameters necessary for wireless LAN connection (communication setting), and the like are stored.

The numeral 108 denotes the image processing unit, which performs development processing for information obtained by the microcomputer 105 from the image sensor 103 through the A/D converter 104. A numeral 120 denotes a compression/decompression processing unit, which performs compression/decompression processing for pixel information primarily stored in the volatile memory 106.

A numeral 117 denotes an accessory detection unit for detecting attachment of the accessory apparatus 200 to the image capturing apparatus 100. A numeral 116 denotes a low speed communication unit for conducting low speed communication with the accessory apparatus 200. The low speed communication unit 116 conducts general purpose low speed communication such as SIO and I2C. A numeral 119 denotes a high speed communication unit for transmission/reception of high-capacity data to and from the accessory apparatus 200. The high speed communication unit 119 can be implemented with general-purpose high speed interfaces such as USB 3.1 and PCI Express. A numeral 115 denotes an accessory power supply unit for supplying power supplied from a battery 123 in the image capturing apparatus 100 to the accessory apparatus 200. When the accessory detection unit 117 detects attachment of the accessory apparatus 200, power is supplied to the accessory apparatus 200 via the accessory power supply unit 115. A numeral 118 denotes an accessory installation unit including a connector to be used to attach the accessory apparatus 200 to the image capturing apparatus 100. The accessory installation unit 118 is connected with the accessory power supply unit 115, the low speed communication unit 116, the accessory detection unit 117, and the high speed communication unit 119.

A numeral 114 denotes a display unit, which displays capturing setting, a state of the image capturing apparatus 100, an ON/OFF state of the first wireless communication unit 121, setting of the attached accessory apparatus 200, or the like to a user. A numeral 111 denotes an operating member configured with buttons, switches and the like, and accepts input from the user. When the operating member 111 accepts input from the user, the microcomputer 105 controls each unit of the image capturing apparatus 100 according to input contents. This achieves an operation of the image capturing apparatus 100 by the user. A numeral 113 denotes a recording medium, which stores an image developed by the image processing unit 108. The recording medium 113 may be built in the image capturing apparatus 100, or may be removable.

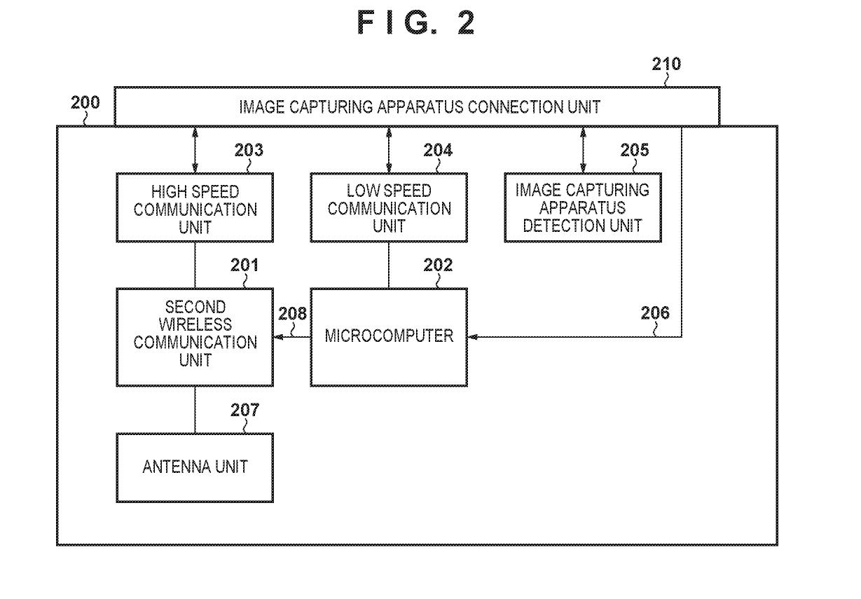

FIG. 2 is a block diagram illustrating a configuration of the accessory apparatus 200. In the following descriptions, the accessory apparatus 200 is referred to as an external wireless LAN accessory, or a communication accessory, in some cases.

In FIG. 2, a numeral 201 denotes a second wireless communication unit. In the present embodiment, the second wireless communication unit 201 supports, in addition to wireless communication in the 2.4 GHz band identical to the first wireless communication unit 121, wireless communication in a 5 GHz band as well. A numeral 207 denotes an antenna unit for emitting a wireless LAN signal output from the second wireless communication unit 201. In the following descriptions, the second wireless communication unit 201 may also be referred to as an external wireless LAN.

A numeral 202 denotes a microcomputer, which communicates with the image capturing apparatus 100 via a low speed communication unit 204. The microcomputer 202 is configured to control the second wireless communication unit 201 by using a control signal 208, according to communication contents with the image capturing apparatus 100.

A numeral 203 denotes a high speed communication unit for conducting high speed communication with the image capturing apparatus 100. The high speed communication unit 203, similar to the high speed communication unit 119, can be implemented with general-purpose high speed interfaces such as USB 3.1 and PCI Express.

A numeral 205 denotes an image capturing apparatus detection unit for detecting that the accessory apparatus 200 is attached to the image capturing apparatus 100. A numeral 206 denotes a power supply line for power supplied from the image capturing apparatus 100. A numeral 210 denotes an image capturing apparatus connection unit including a connector to be used to attach the accessory apparatus 200 to the image capturing apparatus 100. The image capturing apparatus connection unit 210 is connected with the high speed communication unit 203, the low speed communication unit 204, the image capturing apparatus detection unit 205, and the power supply line 206.

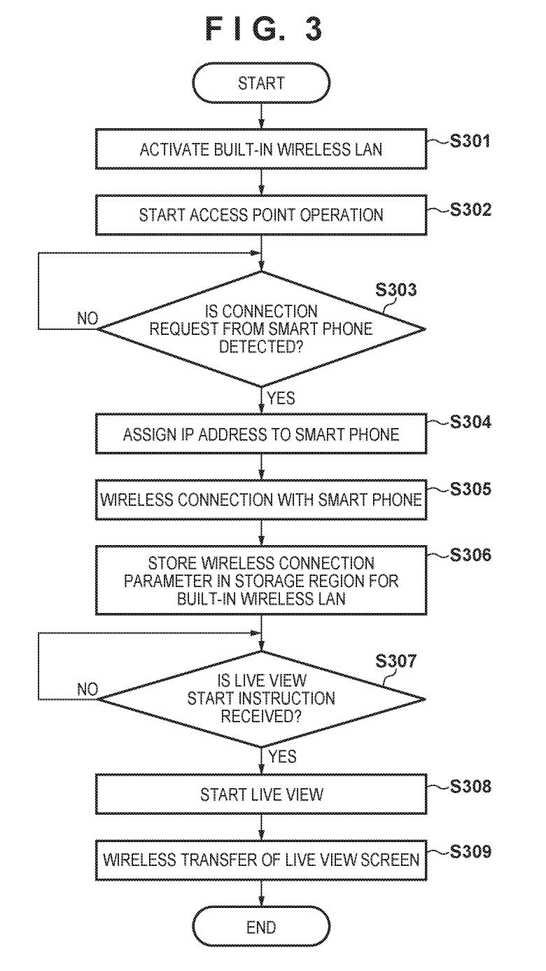

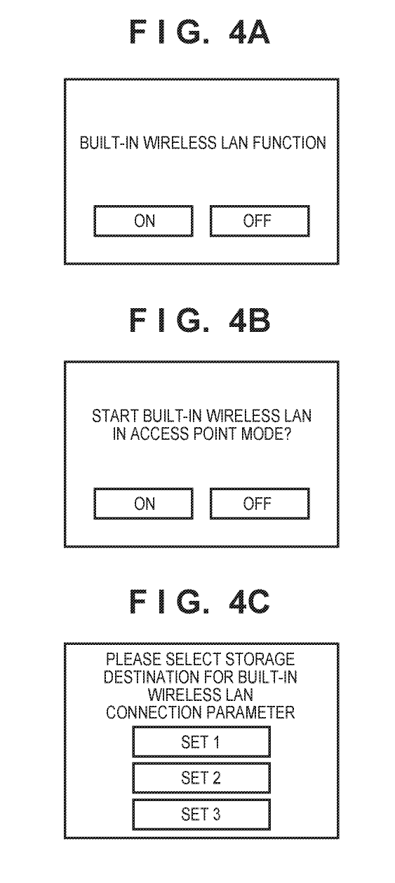

Next, with reference to FIG. 3 and FIGS. 4A to 4C, processing in which the image capturing apparatus 100 achieves remote live view by communicating with a smart phone (not illustrated) by using the built-in wireless LAN will be described.

FIG. 3 is a flowchart of remote live view processing using the built-in wireless LAN. A process in each step of this flowchart, unless otherwise noted, is achieved by the microcomputer 105 that expands a program stored in the non-volatile memory 107 on the volatile memory 106 and executes the program.

In a step S301, the microcomputer 105, according to a user instruction via the operating member 111, displays a menu screen for switching ON/OFF of the built-in wireless LAN function on the display unit 114. FIG. 4A illustrates a menu screen example. When the user selects “ON” through the operating member 111, the microcomputer 105 activates the built-in wireless LAN of the image capturing apparatus 100.

In a step S302, the microcomputer 105 displays a menu screen for selecting whether to start the built-in wireless LAN in an access point mode, on the display unit 114. FIG. 4B illustrates a menu screen example. When the user selects “ON” through the operating member 111, the microcomputer 105 controls access point operation of the built-in wireless LAN to start. In a case where the built-in wireless LAN operates as an access point, the built-in wireless LAN has a DHCP server function. As an SSID or an encryption key (a wireless connection parameter) to be notified across a network, a value previously stored in the non-volatile memory 107 may be used, or a configuration may be adopted in which the user can set an arbitrary value on each occasion. Additionally, as for a radio frequency, a configuration may be adopted in which the image capturing apparatus 100 automatically determines a radio frequency, or a configuration may be adopted in which a user can arbitrarily set a radio frequency, as well.

In a step S303, the microcomputer 105 awaits a connection request from the smart phone. When a connection request is detected, the processing advances to a step S304.

In the step S304, the microcomputer 105 automatically assigns an IP address to the smart phone, using the DHCP server function of the built-in wireless LAN.

In a step S305, the microcomputer 105 wirelessly connects with the smart phone by using the built-in wireless LAN. Thus, an application on the smart phone side and the image capturing apparatus 100 are connected with each other at an application level.

In a step S306, the microcomputer 105 stores a used wireless connection parameter in a storage region for the built-in wireless LAN of the non-volatile memory 107. In this case, for example, the microcomputer 105 displays a menu screen as illustrated in FIG. 4C. In this menu screen, the user can operate the operating member 111 to select a storage destination for the wireless connection parameter. The microcomputer 105 stores the wireless connection parameter in a storage region of the non-volatile memory 107 corresponding to the storage destination (a set name) selected by the user. As described above, by storing the wireless connection parameter used when the wireless connection succeeded inside the image capturing apparatus 100, the user need not perform a cumbersome operation for inputting the wireless connection parameter, when the built-in wireless LAN is used later again. That is, the microcomputer 105 can use the wireless connection parameter stored in the step S306 when performing the process in the step S302 later again.

In a step S307, the microcomputer 105 awaits a live view start instruction from the smart phone. When a live view start instruction is received, the processing advances to a step S308.

In the step S308, the microcomputer 105 controls a process for transferring a live view screen based on an image obtained by the image sensor 103 to the smart phone by using the built-in wireless LAN, to start.

In a step S309, the microcomputer 105 transfers the live view screen to the smart phone by using the built-in wireless LAN. In this case, the microcomputer 105 generates an image with an image size appropriate for the smart phone by using the compression/decompression processing unit 120, and transfers the image to the smart phone via the first wireless communication unit 121. This achieves live view display in the smart phone. The wireless transferring of the live view screen in the step S309 continues until a live view end instruction is generated.

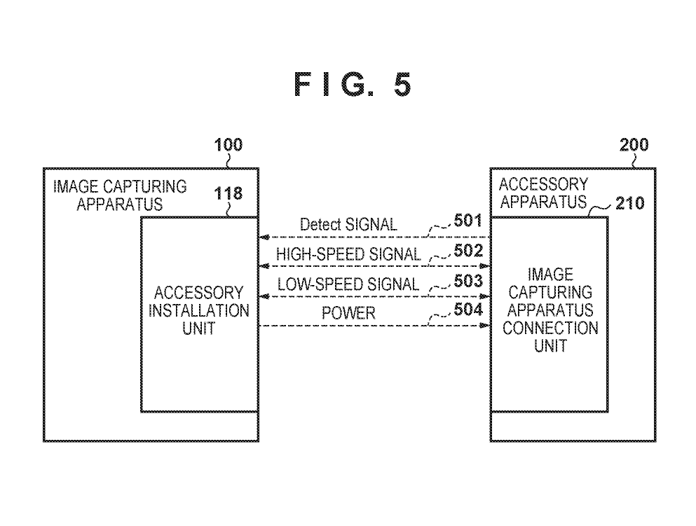

Next, with reference to FIG. 5 through FIGS. 7A to 7C, processing in which the image capturing apparatus 100 achieves the remote live view by communicating with the smart phone by using the external wireless LAN will be described.

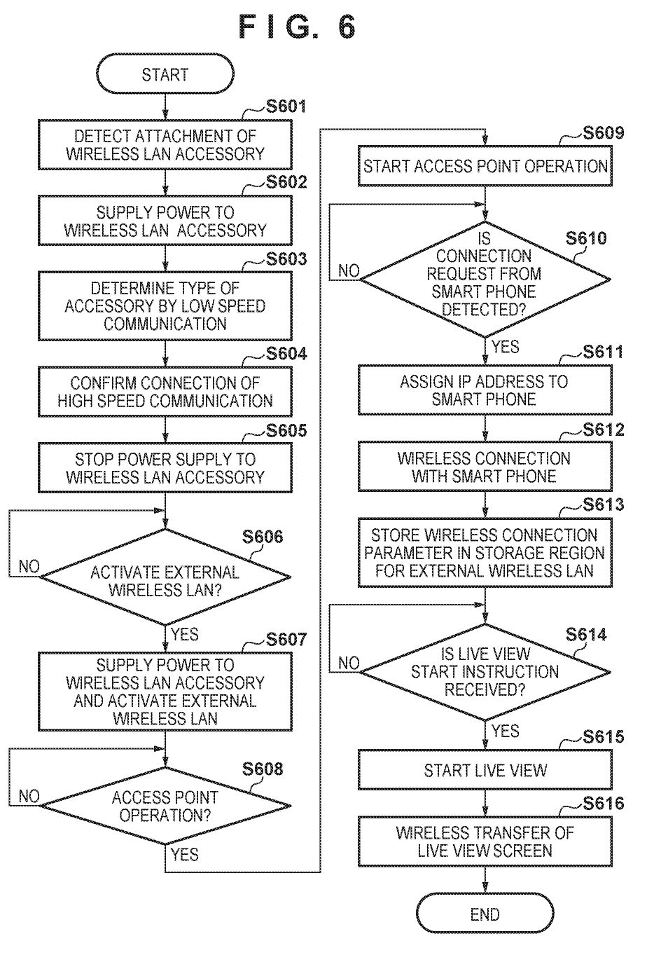

FIG. 6 is a flowchart of the remote live view processing using the external wireless LAN. A process in each step of this flowchart, unless otherwise noted, is achieved by the microcomputer 105 that expands a program stored in the non-volatile memory 107 on the volatile memory 106 and executes the program.

In this case, assume that wireless communication using the built-in wireless LAN is not being conducted. A process will be described later for the case in which switching to wireless communication using the external wireless LAN is performed while the wireless communication using the built-in wireless LAN is being conducted.

In a step S601, the user attaches the accessory apparatus 200 to the accessory installation unit 118 of the image capturing apparatus 100. The microcomputer 105 detects that the accessory apparatus 200 is attached to the accessory installation unit 118. FIG. 5 is a diagram for explaining connection between the accessory installation unit 118 of the image capturing apparatus 100 and the image capturing apparatus connection unit 210 of the accessory apparatus 200. The microcomputer 105 detects that the accessory apparatus 200 is attached, by detecting a Detect signal 501 via the accessory detection unit 117.

In a step S602, the microcomputer 105 supplies power from the battery 123 to the accessory apparatus 200 via a power supply line 504.

In a step S603, the microcomputer 105 determines a type of the accessory apparatus 200 by using a low speed signal 503. The low speed signal 503 is transmitted by general purpose low speed communication such as SIO or I2C. The microcomputer 105 uses the above general purpose low speed communication technology to communicate with the microcomputer 202 of the accessory apparatus 200, to determine the type of the accessory apparatus 200. In this case, the type of the accessory apparatus 200 is a wireless LAN apparatus.

In a step S604, the microcomputer 105 uses a high-speed signal 502 and accesses the second wireless communication unit 201 of the accessory apparatus 200, to confirm that high speed communication is normally connected. When the connection confirmation succeeds, the microcomputer 105 determines that the accessory apparatus 200 is correctly attached to the image capturing apparatus 100.

In a step S605, the microcomputer 105 stops the power supply to the accessory apparatus 200.

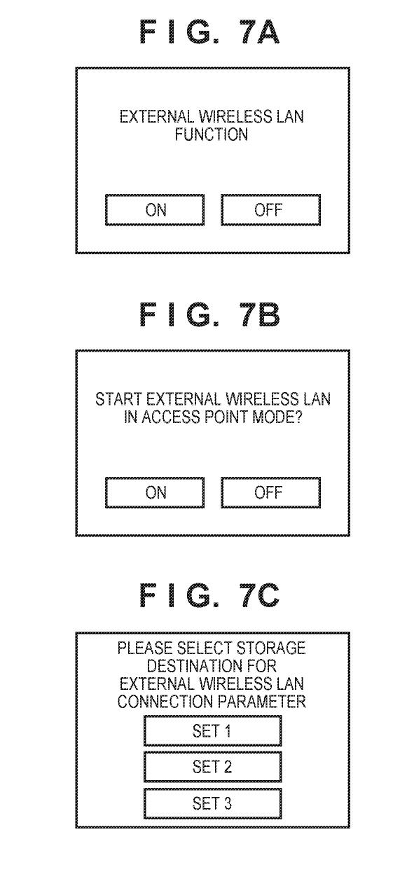

In a step S606, the microcomputer 105 awaits an instruction for activating the external wireless LAN. Specifically, the microcomputer 105 displays a menu screen for switching ON/OFF of an external wireless LAN function on the display unit 114. FIG. 7A illustrates a menu screen example. When the user selects “ON” through the operating member 111, the microcomputer 105 determines that activation of the external wireless LAN is instructed and advances the processing to a step S607.

In the step S607, the microcomputer 105 supplies power to the accessory apparatus 200 again to activate the external wireless LAN.

In a step S608, the microcomputer 105 awaits an instruction for starting the external wireless LAN in the access point mode. Specifically, the microcomputer 105 displays a menu screen for selecting whether to start the external wireless LAN in the access point mode, on the display unit 114. FIG. 7B illustrates a menu screen example. When the user selects “ON” through the operating member 111, the microcomputer 105 determines that start-up of the external wireless LAN in the access point mode is instructed and advances the processing to a step S609.

In the step S609, the microcomputer 105 controls an access point operation of the external wireless LAN to start. In a case where the external wireless LAN operates as an access point, the external wireless LAN has a DHCP server function. As an SSID or an encryption key (a wireless connection parameter) to be notified across a network, a value previously stored in the non-volatile memory 107 may be used, or a configuration may be adopted in which the user can set an arbitrary value on each occasion. Additionally, as for a radio frequency, a configuration may be adopted in which the image capturing apparatus 100 automatically determines a radio frequency, or a configuration may be adopted in which a user can arbitrarily set a radio frequency, as well.

In a step S610, the microcomputer 105 awaits a connection request from the smart phone. When a connection request is detected, the processing advances to a step S611.

In the step S611, the microcomputer 105 automatically assigns an IP address to the smart phone, using the DHCP server function of the external wireless LAN.

In a step S612, the microcomputer 105 wirelessly connects with the smart phone by using the external wireless LAN. Thus, an application on the smart phone side and the image capturing apparatus 100 are connected with each other at an application level.

In a step S613, the microcomputer 105 stores a used wireless connection parameter in a storage region for the external wireless LAN of the non-volatile memory 107. In this case, for example, the microcomputer 105 displays a menu screen as illustrated in FIG. 7C. In this menu screen, the user can operate the operating member 111 to select a storage destination for the wireless connection parameter. The microcomputer 105 stores the wireless connection parameter in a storage region of the non-volatile memory 107 corresponding to the storage destination (a set name) selected by the user. As described above, by storing the wireless connection parameter used when the wireless connection succeeded inside the image capturing apparatus 100, the user need not perform a cumbersome operation for inputting the wireless connection parameter when the external wireless LAN is used later again. That is, the microcomputer 105 can use the wireless connection parameter stored in the step S613 when performing the process in the step S609 later again.

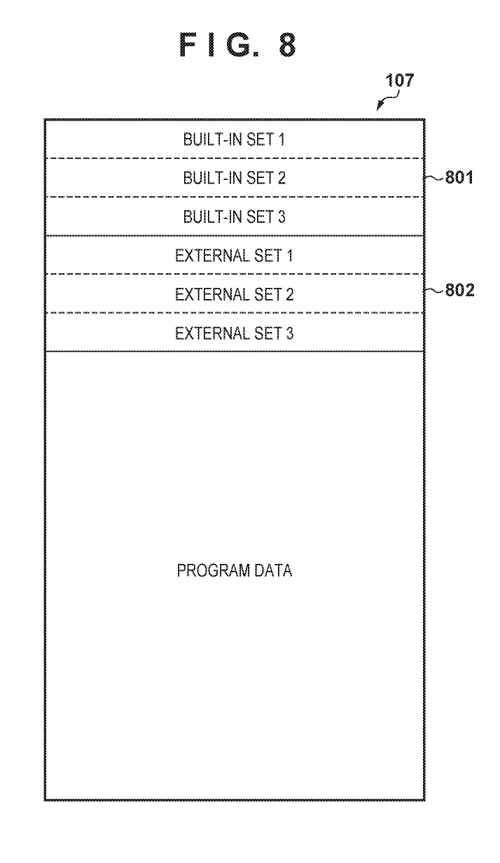

Both the process in the step S306 performed when the above-described built-in wireless LAN is used, and the process in the step S613 performed when the external wireless LAN is used are processes for recording the wireless connection parameter in the non-volatile memory 107, but the recording regions are different. FIG. 8 illustrates a memory map of the non-volatile memory 107. As illustrated in FIG. 8, the wireless connection parameter for the built-in wireless LAN is stored in a storage region 801, and the wireless connection parameter for the external wireless LAN is stored in a storage region 802. As described above, the image capturing apparatus 100 is configured to independently manage the wireless connection parameter for the built-in wireless LAN, and the wireless connection parameter for the external wireless LAN. Since the user can manage the wireless connection parameter for each wireless LAN function to use, overwriting on the wireless connection parameter by mistake can be prevented. Additionally, a user-friendly image capturing apparatus of which operations are easy-to-understand can be provided.

With reference to FIG. 6 again, in a step S614, the microcomputer 105 awaits a live view start instruction from the smart phone. When the live view start instruction is received, the processing advances to a step S615.

In the step S615, the microcomputer 105 controls a process for transferring a live view screen based on the image obtained by the image sensor 103 to the smart phone by using the external wireless LAN, to start.

In a step S616, the microcomputer 105 transfers the live view screen to the smart phone by using the external wireless LAN. In this case, the microcomputer 105 generates an image with an image size appropriate for the smart phone by using the compression/decompression processing unit 120, and transfers the image to the smart phone via the second wireless communication unit 201. This achieves live view display in the smart phone. The wireless transferring of the live view screen in the step S616 continues until a live view end instruction is generated.

In the description of FIG. 6, in a situation that the wireless communication using the built-in wireless LAN is not conducted, the usage of the external wireless LAN starts. In this case, as described above with reference to FIG. 8, the image capturing apparatus 100 stores the wireless connection parameter for the built-in wireless LAN and the wireless connection parameter for the external wireless LAN in the different storage regions of the non-volatile memory 107.

However, the user wants to switch the wireless communication to the external wireless LAN while the wireless communication using the built-in wireless LAN is being conducted in some cases. For example, a case is conceivable where, while the wireless communication using the built-in wireless LAN is being conducted, the user attaches an external wireless LAN accessory to the image capturing apparatus 100 to extend a communication distance with a communication partner device. In this case, it is conceivable that the user wants smooth switching from the wireless communication using the built-in wireless LAN to the wireless communication using the external wireless LAN. Thus, the image capturing apparatus 100 includes a configuration in which switching to the wireless communication using the external wireless LAN is performed in a case where the external wireless LAN accessory is attached while the wireless communication using the built-in wireless LAN is being conducted.

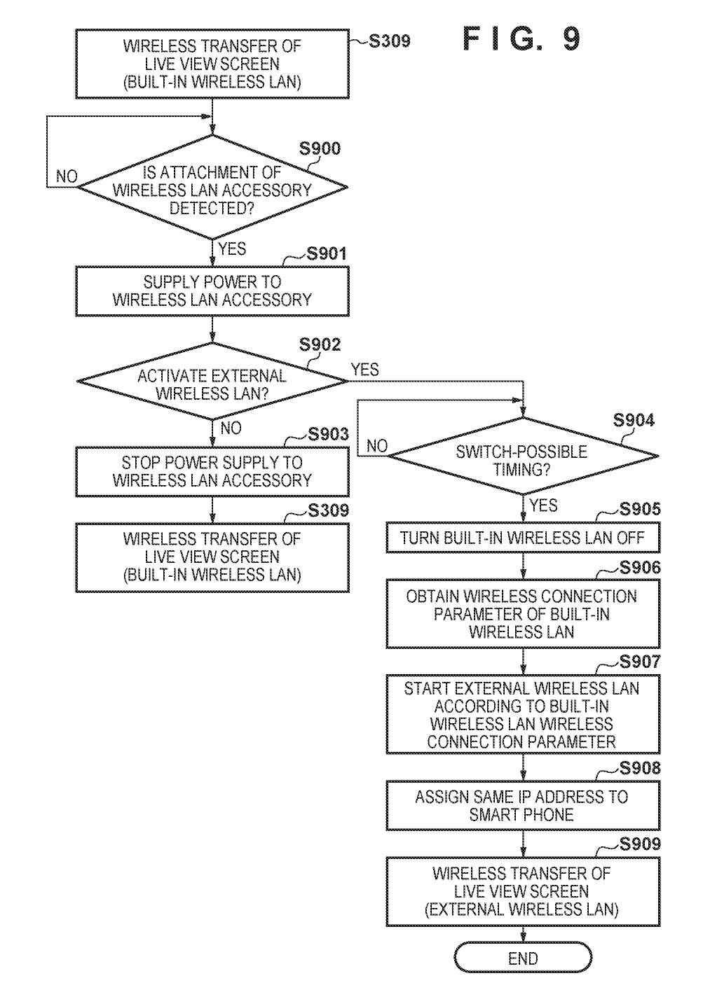

FIG. 9 is a flowchart of switching processing of wireless communication according to the first embodiment. A process in each step of this flowchart, unless otherwise noted, is achieved by the microcomputer 105 that expands a program stored in the non-volatile memory 107 on the volatile memory 106 and executes the program. The step S309 in FIG. 9 corresponds to the step S309 in FIG. 3. That is, while a live view screen is being transferred using the built-in wireless LAN, processes in and after a step S900 in FIG. 9 are performed in parallel.

In the step S900, the microcomputer 105 awaits the accessory apparatus 200 to be attached to the accessory installation unit 118. When the attachment of the accessory apparatus 200 is detected, the processing advances to a step S901.

In the step S901, the microcomputer 105 supplies power from the battery 123 to the accessory apparatus 200 via the power supply line 504.

In a step S902, the microcomputer 105 displays a menu screen for selecting ON/OFF of the external wireless LAN function on the display unit 114. As this menu screen, for example, the menu screen illustrated in FIG. 7A can be used. Alternatively, a message for the user to recognize that switching from the built-in wireless LAN to the external wireless LAN is to be performed may be included in a menu screen. The microcomputer 105, based on the selection by the user on the menu screen, determines whether to activate the external wireless LAN. When the user selects “ON” through the operating member 111, the microcomputer 105 determines to activate the external wireless LAN and advances the processing to a step S904. When the user selects “OFF” through the operating member 111, the microcomputer 105 determines not to activate the external wireless LAN and advances the processing to a step S903.

In the step S903, the microcomputer 105 stops the power supply to the accessory apparatus 200. Subsequently, the microcomputer 105 continues transferring the live view screen by using the built-in wireless LAN in the step S309.

In the step S904, the microcomputer 105 determines whether it is timing at which the switching from the built-in wireless LAN to the external wireless LAN is possible (predetermined switch-possible timing). When the switching from the built-in wireless LAN to the external wireless LAN is performed while the live view screen is being transferred (i.e., while the remote live view is in progress), since the wireless communication cannot be conducted during the switching processing, live view display on the smart phone side may be interrupted. Accordingly, the microcomputer 105, during a period in which pixel information is read by the image sensor 103, determines that the switching is not possible at the timing, and does not perform transition to a step S905. On the other hand, in a case where the image capturing apparatus 100 enters an operation mode in which the user remotely browses the captured image in the recording medium 113, the microcomputer 105 determines that the switching is possible at the timing, and advances the processing to a step S905. That is, the microcomputer 105, while data requiring a real-time characteristic such as the live view screen are being transferred, does not perform transition to the step S905. Meanwhile, the microcomputer 105, while data not requiring the real-time characteristic such as the captured image are being transferred, performs transition to the step S905.

In the step S905, the microcomputer 105 performs a process for turning OFF the function of the built-in wireless LAN. For example, the microcomputer 105 stops power supply to the built-in wireless LAN. As long as a purpose of stopping a wireless function of the built-in wireless LAN is achieved, an arbitrary process other than power shutdown may be performed.

In a step S906, the microcomputer 105 obtains a wireless connection parameter used by the built-in wireless LAN up till then from the non-volatile memory 107.

In a step S907, the microcomputer 105 starts the external wireless LAN according to the wireless connection parameter obtained in the step S906.

In a step S908, the microcomputer 105 assigns an identical IP address to the smart phone (the IP address assigned to the smart phone in the wireless communication using the built-in wireless LAN until then). This completes connection with the smart phone using the external wireless LAN. In a case where the switching from the built-in wireless LAN to the external wireless LAN is performed as described above, the user does not set the wireless connection parameter for the external wireless LAN. Thus, unlike the step S613 in FIG. 6, the microcomputer 105 does not store the wireless connection parameter in the non-volatile memory 107.

As described above, the identical wireless connection parameter is used to start wireless communication via the external wireless LAN, and thus this can allow the user not to recognize temporary disconnection of the wireless communication caused by the switching from the built-in wireless LAN to the external wireless LAN. Further, since the identical IP address is assigned to the smart phone before and after the switching, an application of the smart phone can continue processing without regard to the temporary disconnection of the wireless communication.

In a step S909, the microcomputer 105 transfers the live view screen to the smart phone by using the external wireless LAN. The wireless transferring of the live view screen in the step S909 continues until a live view end instruction is generated.

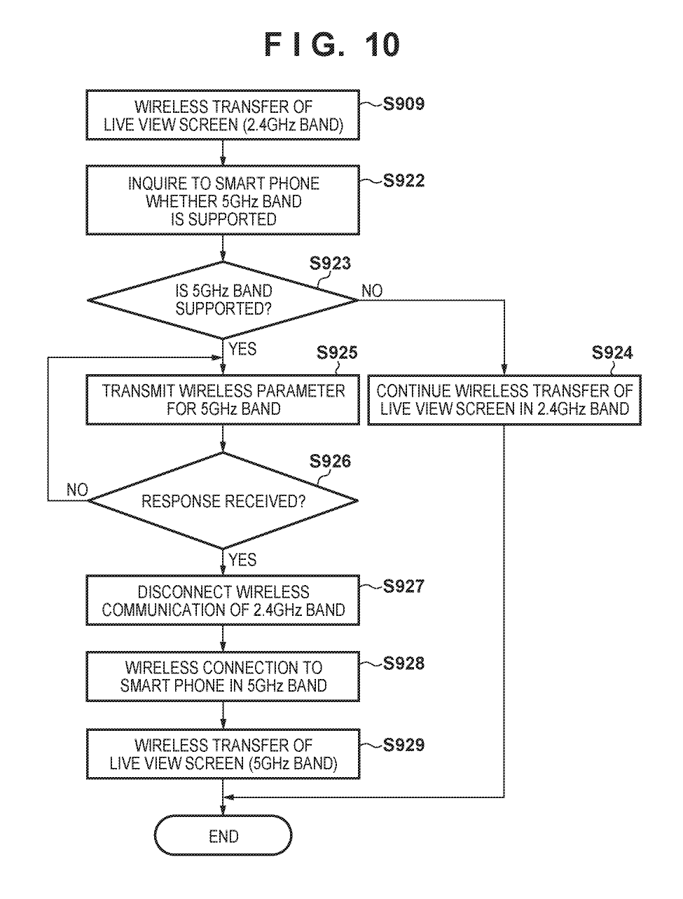

Next, with reference to FIG. 10, frequency switching processing to be performed after the switching processing of the wireless communication (FIG. 9) will be described. As described above, in the step S909 in FIG. 9, the process is performed for transferring the live view screen to the smart phone by using the external wireless LAN. This transferring is performed by the wireless communication in the 2.4 GHz band. The frequency switching processing described later is, in a case where the smart phone supports the 5 GHz band, processing for switching a frequency band of this wireless communication from the 2.4 GHz band to the 5 GHz band.

A process in each step of a flowchart in FIG. 10, unless otherwise noted, is achieved by the microcomputer 105 that expands a program stored in the non-volatile memory 107 on the volatile memory 106 and executes the program. Additionally, the step S909 in FIG. 10 corresponds to the step S909 in FIG. 9. That is, while the live view screen is being transferred using the external wireless LAN, processes in and after a step S922 in FIG. 10 are performed in parallel.

In the step S922, the microcomputer 105 inquires of the smart phone about whether the 5 GHz band is supported. This inquiry is performed by the wireless communication in the 2.4 GHz band.

In a step S923, the microcomputer 105 determines, based on a result of the inquiry in the step S922, whether the smart phone supports the 5 GHz band. In a case where the smart phone supports the 5 GHz band, the processing advances to a step S925, otherwise, the processing advances to a step S924.

In the step S924, the microcomputer 105 continues the wireless transferring of the live view screen in the 2.4 GHz band. The wireless transferring of the live view screen in the step S924 continues until a live view end instruction is generated.

In the step S925, the microcomputer 105 uses the wireless communication in the 2.4 GHz band to transmit a wireless connection parameter (e.g., an SSID or an encryption key) for conducting wireless communication in the 5 GHz band to the smart phone.

In the present embodiment, as the wireless connection parameter for the 5 GHz band, a parameter is used which is different from the wireless connection parameter for the current 2.4 GHz band. This makes it possible to prevent, when the wireless communication in the 5 GHz band is established, establishment of the wireless communication in the 2.4 GHz band by mistake. Additionally, by using a different encryption key for the wireless communication in the 5 GHz band, more secure wireless communication can be provided.

In a step S926, the microcomputer 105 determines whether a response from the smart phone indicating reception of the wireless connection parameter for the 5 GHz band is received. In a case where the response is received, the processing advances to a step S927, otherwise, the processing returns to the step S925.

In a step S927, the microcomputer 105 disconnects the wireless communication in the 2.4 GHz band.

In a step S928, the microcomputer 105 wirelessly connects with the smart phone in the 5 GHz band by using the external wireless LAN, by using the wireless connection parameter for the 5 GHz band transmitted in the step S925.

In a step S929, the microcomputer 105 transfers the live view screen to the smart phone by using the wireless communication in the 5 GHz band. The wireless transferring of the live view screen in the step S929 continues until a live view end instruction is generated.

As described above, according to the first embodiment, the image capturing apparatus 100 detects a communication execution instruction about the external wireless LAN accessory. This communication execution instruction is, for example, detected in response to the attachment of the external wireless LAN accessory to the accessory installation unit 118. However, the image capturing apparatus 100 may be configured to detect the communication execution instruction in response to another condition (e.g., a menu operation by the user). In a case where the communication execution instruction is detected while the wireless communication to and from the smart phone (an external apparatus) is being conducted via the built-in wireless LAN, the image capturing apparatus 100 stops the wireless communication via the built-in wireless LAN, and controls the wireless communication to and from the smart phone to be conducted via the external wireless LAN. At this time, the image capturing apparatus 100, according to an identical wireless connection parameter to the wireless connection parameter (setting information) used for the wireless communication via the built-in wireless LAN, conducts the wireless communication via the external wireless LAN. On the other hand, in a case where a communication execution instruction is detected when the wireless communication via the built-in wireless LAN is not conducted, the image capturing apparatus 100 performs different control. Specifically, the image capturing apparatus 100, according to a different wireless connection parameter from the wireless connection parameter for the built-in wireless LAN, controls the wireless communication to and from the smart phone to be conducted via the external wireless LAN. Thus, according to the first embodiment, when the wireless communication is conducted, according to whether another wireless communication is being conducted, appropriate communication setting can be used.

Note that, in FIG. 9, as an example of a case where the communication execution instruction is detected while the wireless communication via the built-in wireless LAN is being conducted, the case was described where the external wireless LAN is activated while the live view screen is transferred using the built-in wireless LAN. However, in the present embodiment, “while the wireless communication is being conducted” is not limited to duration in which the live view screen is transferred, and, for example, may include a state in which the image capturing apparatus 100 and the smart phone establish wireless communication, but do not transmit/receive data.

### Second Embodiment

In a second embodiment, another example of the switching processing of the wireless communication (FIG. 9) described in the first embodiment will be described. In the present embodiment, a basic configuration of each of the image capturing apparatus 100 and the accessory apparatus 200 is similar to that in the first embodiment (see FIG. 1 and FIG. 2). In the following, differences from the first embodiment will mainly be described.

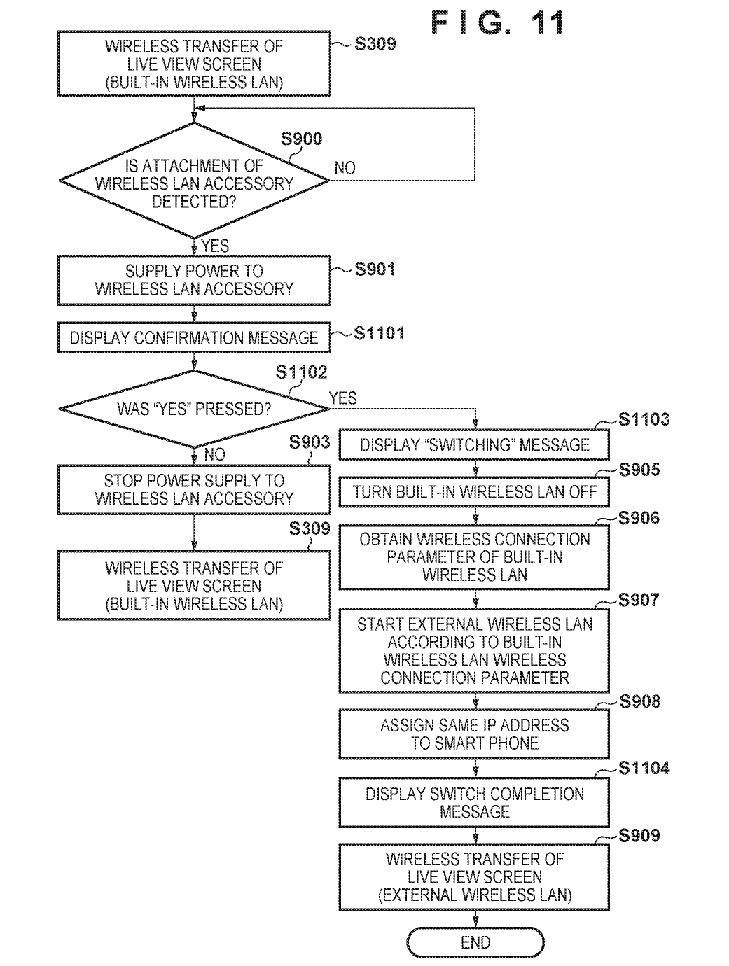

FIG. 11 is a flowchart of switching processing of wireless communication according to the second embodiment. A process in each step of this flowchart, unless otherwise noted, is achieved by the microcomputer 105 that expands a program stored in the non-volatile memory 107 on the volatile memory 106 and executes the program. The step S309 in FIG. 11 corresponds to the step S309 in FIG. 3. That is, while the live view screen is being transferred using the built-in wireless LAN, processes in and after the step S900 in FIG. 11 are performed in parallel.

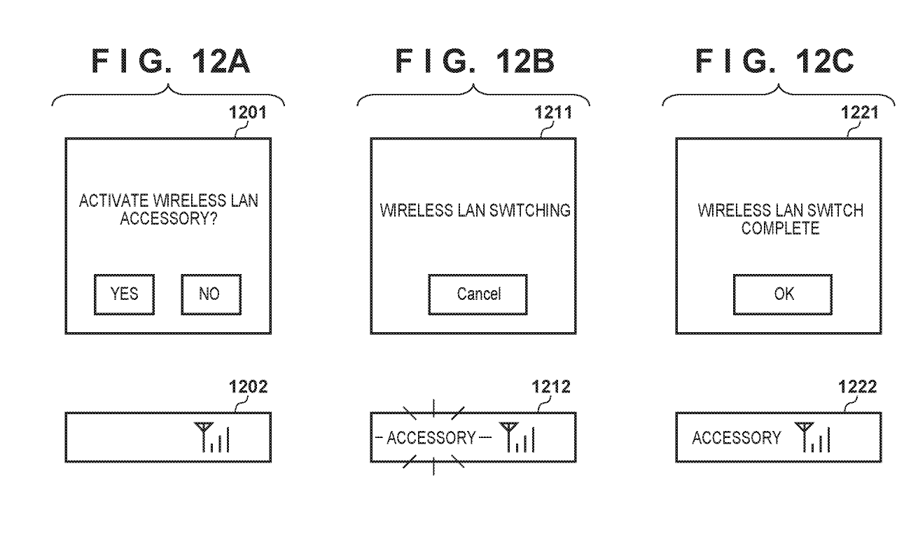

In a step S1101, the microcomputer 105 displays a message for confirming whether to activate an external wireless LAN accessory (e.g., a confirmation message 1201 illustrated in FIG. 12A) on the display unit 114.

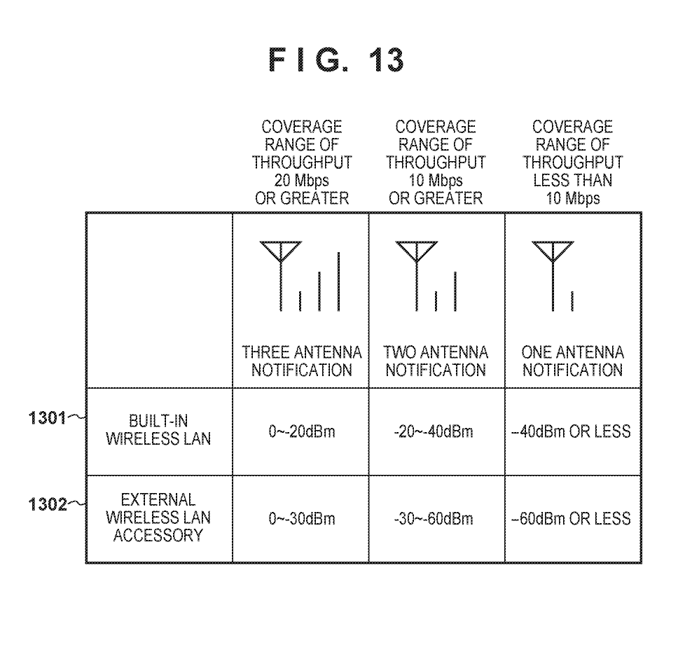

Note that, while the built-in wireless LAN is used, the microcomputer 105 may display a screen 1202 illustrated in FIG. 12A on the display unit 114 or another display unit (e.g., a display unit in a viewfinder). The screen 1202 indicates that the built-in wireless LAN is in use. The screen 1202 contains antenna radio field intensity display. The antenna radio field intensity display is selected based on a threshold value for the built-in wireless LAN denoted by a numeral 1301 in FIG. 13.

In a step S1102, the microcomputer 105 determines whether the user selects “YES” in the confirmation message 1201. In a case where “YES” is selected, the processing advances to a step S1103, and in a case where “NO” is selected, the processing advances to the step S903.

In a step S1103, the microcomputer 105 displays a message indicating that the wireless LAN is being switched (e.g., a switching message 1211 illustrated in FIG. 12B) on the display unit 114. Additionally, the microcomputer 105 may display a screen 1212 illustrated in FIG. 12B on the display unit 114 or another display unit (e.g., a display unit in a viewfinder).

In a step S1104, the microcomputer 105 displays a message indicating that the switching from the built-in wireless LAN to the external wireless LAN is completed (e.g., a switching completion message 1221 illustrated in FIG. 12C) on the display unit 114. Further, the microcomputer 105 may display a screen 1222 illustrated in FIG. 12C on the display unit 114 or another display unit (e.g., a display unit in a viewfinder). Antenna radio field intensity display contained in the screen 1222 is selected based on a threshold value for the external wireless LAN accessory denoted by a numeral 1302 in FIG. 13.

As described above, according to the second embodiment, various messages indicating progress status of the switching processing of the wireless communication are displayed. Thus, the user can easily recognize the progress status of the switching processing of the wireless communication.

### Third Embodiment

In a third embodiment, switching from the external wireless LAN to the built-in wireless LAN will be described. In the present embodiment, a basic configuration of each of the image capturing apparatus 100 and the accessory apparatus 200 is similar to that in the first embodiment (see FIG. 1 and FIG. 2). In the following, differences from the first embodiment will mainly be described.

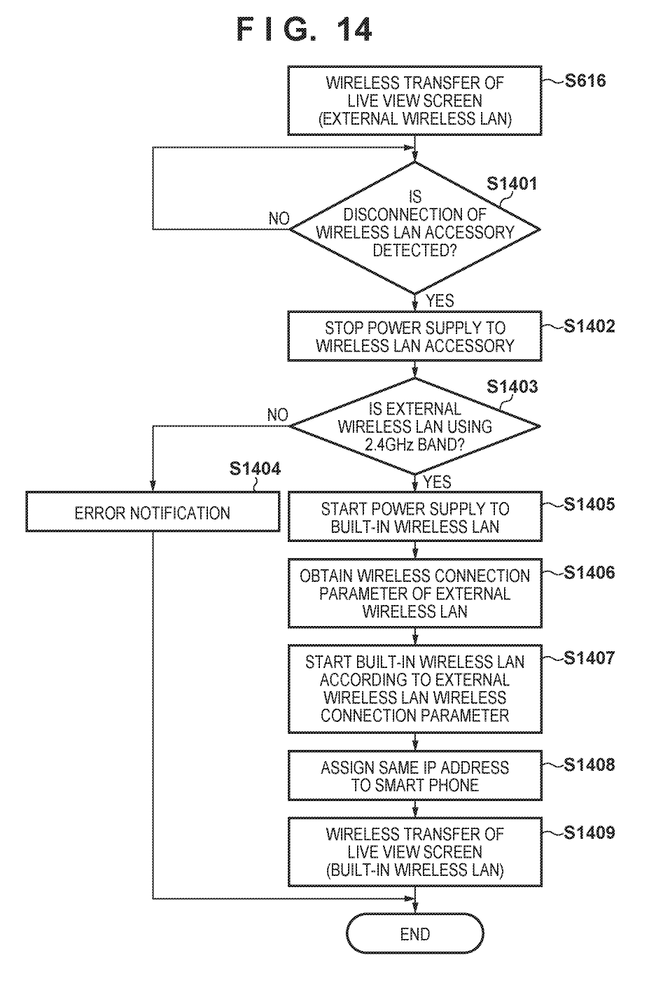

FIG. 14 is a flowchart of switching processing of wireless communication according to the third embodiment. A process in each step of this flowchart, unless otherwise noted, is achieved by the microcomputer 105 that expands a program stored in the non-volatile memory 107 on the volatile memory 106 and executes the program. The step S616 in FIG. 14 corresponds to the step S616 in FIG. 6. That is, while the live view screen is being transferred using the external wireless LAN, processes in and after a step S1401 in FIG. 14 are performed in parallel. Note that, processing in this flowchart may be performed while the live view screen is being transferred in the step S909 in FIG. 9.

In the step S1401, the microcomputer 105 determines whether disconnection (removal) of the external wireless LAN accessory is detected. The disconnection of the external wireless LAN accessory may occur due to an accident not intended by the user, for example. When the disconnection of the external wireless LAN accessory is detected, the processing advances to a step S1402.

In the step S1402, the microcomputer 105 stops the power supply to the external wireless LAN accessory.

In a step S1403, the microcomputer 105 determines whether a frequency band used by the external wireless LAN up till then is the 2.4 GHz band. In a case of the 2.4 GHz band, the processing advances to a step S1405, otherwise, the processing advances to a step S1404.

In the step S1404, the microcomputer 105 notifies an error.

For example, in the step S1405, the microcomputer 105 starts power supply to the built-in wireless LAN.

In a step S1406, the microcomputer 105 obtains a wireless connection parameter used by the external wireless LAN up till then from the non-volatile memory 107.

In a step S1407, the microcomputer 105 starts the built-in wireless LAN according to the wireless connection parameter obtained in the step S1406.

In a step S1408, the microcomputer 105 assigns an identical IP address to the smart phone (the IP address assigned to the smart phone in the wireless communication using the external wireless LAN accessory until then). This completes connection with the smart phone by using the built-in wireless LAN. In a case where the switching from the external wireless LAN to the built-in wireless LAN is performed as described above, the user does not set the wireless connection parameter for the built-in wireless LAN. Thus, unlike the step S306 in FIG. 3, the microcomputer 105 does not store the wireless connection parameter in the non-volatile memory 107.

In a step S1409, the microcomputer 105 transfers the live view screen to the smart phone by using the built-in wireless LAN. The wireless transferring of the live view screen in the step S1409 continues until a live view end instruction is generated.

As described above, according to the third embodiment, in the case where the external wireless LAN accessory is disconnected, the wireless communication can be continued using the built-in wireless LAN.

### Other Embodiments

Embodiment(s) of the present invention can also be realized by a computer of a system or apparatus that reads out and executes computer executable instructions (e.g., one or more programs) recorded on a storage medium (which may also be referred to more fully as anon-transitory computer-readable storage medium′) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-039642, filed Mar. 6, 2018, which is hereby incorporated by reference herein in its entirety.

What is claimed is:

1. A communication control apparatus, comprising:
a control unit configured to perform control such that first wireless communication with an external apparatus is conducted via a first communication unit according to first setting information; and
a detection unit configured to detect a communication execution instruction about a second communication unit, wherein the control unit is configured to, in a case where the communication execution instruction is detected while the first wireless communication is being conducted, stop the first wireless communication, and perform control such that second wireless communication with the external apparatus is conducted via the second communication unit according to the first setting information, and the control unit is configured to, in a case where the communication execution instruction is detected when the first wireless communication is not conducted, perform control such that third wireless communication with the external apparatus is conducted via the second communication unit according to second setting information different from the first setting information.

2. The communication control apparatus according to claim 1, wherein the control unit is configured to perform control such that an identical IP address is assigned to the external apparatus for the first wireless communication and the second wireless communication.

3. The communication control apparatus according to claim 1, wherein the first wireless communication and the second wireless communication are wireless communication using a first frequency band,
the control unit is configured to,
while the second wireless communication is being conducted, determine whether the external apparatus supports a second frequency band different from the first frequency band, and
in a case where the external apparatus supports the second frequency band, perform control such that fourth wireless communication using the second frequency band is conducted with the external apparatus via the second communication unit, according to third setting information different from the first setting information.

4. The communication control apparatus according to claim 1, wherein
the control unit is configured to, in a case where the communication execution instruction is detected while the first wireless communication is being conducted, await predetermined switch-possible timing, and perform control such that, at the predetermined switch-possible timing, the first wireless communication is stopped and the second wireless communication is conducted.

5. The communication control apparatus according to claim 1, further comprising:
an attachment unit configured to be attached with a communication accessory including the second communication unit, wherein
the detection unit is configured to detect the communication execution instruction in response to attachment of the communication accessory to the attachment unit.

6. The communication control apparatus according to claim 5, wherein
the control unit is configured to, in a case where the communication accessory is removed from the attachment unit while the second wireless communication is being conducted, perform control such that fifth wireless communication with the external apparatus is conducted via the first communication unit according to the second setting information.

7. A communication control apparatus, comprising:
a control unit configured to control a first communication device built in a communication apparatus, and a second communication device attached to the communication apparatus; and
a detection unit configured to detect a communication execution instruction about the second communication device, wherein
the control unit is configured to, in a case where the detection unit detects the communication execution instruction while the first communication device is conducting wireless communication with an external apparatus via a communication network formed by the first communication device, perform control such that wireless communication by the first communication device is stopped, and the second communication device uses setting regarding the communication network to form a new communication network and conducts wireless communication with the external apparatus via the newly formed communication network.

8. The communication control apparatus according to claim 7, wherein
the control unit is configured to, when starting wireless communication by the second communication device, assign an IP address set for the external apparatus in wireless communication by the first communication device to the external apparatus.

9. The communication control apparatus according to claim 7, wherein
the detection unit is configured to, according to attachment of the second communication device while wireless communication by the first communication device is being conducted, detect the communication execution instruction about the second communication device.

10. The communication control apparatus according to claim 7, wherein
the second communication device is configured to be capable of communicating using a second frequency band different from a first frequency band used for wireless communication by the first communication device, and
the control unit is configured to, while wireless communication is being conducted by the first communication device, determine whether the external apparatus supports the second frequency band, and in a case where the external apparatus supports the second frequency band, perform control such that wireless communication with the external apparatus is conducted using the second frequency band.

11. The communication control apparatus, according to claim 10, wherein the control unit is configured to perform control such that the second communication device uses different setting from setting of a communication network formed by the first communication device to form a new communication network and conducts wireless communication with the external apparatus via the newly formed communication network by using the second frequency band.

12. A communication control method executed by a communication control apparatus, comprising:
performing control such that first wireless communication with an external apparatus is conducted via a first communication unit according to first setting information;
detecting a communication execution instruction about a second communication unit;
in a case where the communication execution instruction is detected while the first wireless communication is being conducted, stopping the first wireless communication, and performing control such that second wireless communication with the external apparatus is conducted via the second communication unit according to the first setting information; and
in a case where the communication execution instruction is detected when the first wireless communication is not conducted, performing control such that third wireless communication with the external apparatus is conducted via the second communication unit according to second setting information different from the first setting information.

13. A communication control method executed by a communication control apparatus, comprising:
detecting a communication execution instruction about a second communication device attached to a communication apparatus; and
in a case where the communication execution instruction is detected while a first communication device built in the communication apparatus is conducting wireless communication with an external apparatus via a communication network formed by the first communication device, performing control such that wireless communication by the first communication device is stopped, and the second communication device uses setting regarding the communication network to form a new communication network and conducts wireless communication with the external apparatus via the newly formed communication network.
